(19) United States
(12) Patent Application Publication
(10) Pub. No.: US 2016/0327260 A1
(43) Pub. Date: Nov. 10, 2016

(54) Work light assembly with wireless communication networking

(71) Applicant: Globe Electric Company Inc., Montreal (CA)

(72) Inventor: Adam Chaimberg, Hampstead (CA)

(73) Assignee: Globe Electric Company Inc.

(21) Appl. No.: 14/545,455

(22) Filed: May 7, 2015

(51) Int. Cl. F21V 33/00; H04M 1/18; F21V 23/06; F21V 21/30; F21V 31/00

(52) U.S. Cl. CPC F21V 33/0052; F21V 21/30; F21V 31/00; F21V 23/06; H04M 1/18; F21W 2131/1005

(57) ABSTRACT

A work light assembly having a support provided with a ground engaging frame and an above-ground frame for supporting one or two work lights at a desired orientation. A dust proof sealed housing has a speaker and integrated microphone and incorporates therein wireless network technology including, but not limited to, Bluetooth and WiFi for two-way communication or for downloading music or downloading and receiving other information.

### TECHNICAL FIELD

The present invention relates to a work light assembly incorporating a sealed housing having wireless network technology to provide two-way communication between a user person and a remote location.

### BACKGROUND OF THE INVENTION

The use of work lights for use by trade persons or others is known whereby to illuminate a space to perform job functions at nighttime or to shed light on objects, such as on walls to detect imperfections of jointing compound whereby a trade person can fix the imperfections, or for inspecting paint, and many other night time or daytime uses. Trade persons also enjoy music or listening to the radio while performing their job functions and this requires the use of a portable radio usually incorporating therewith a CD player. Most trade persons also carry with them cellular telephones for communication with other persons while on the job site. These electronic devices are often exposed to dust and can get damaged and require maintenance to keep them in good working order.

Another problem with the use of cellphones or other mobile devices on worksites is that these devices often get misplaced and lost or are disposed at distances where their ring tone cannot be heard. They are also often forgotten on the worksite. Portable radio devices also deteriorate or malfunction when exposed to dust and are often left on a worksite for several days when the job function requires several days to perform risking that the radio device is stolen.

### SUMMARY OF THE INVENTION

It is a feature of the present invention to provide a work light assembly which substantially overcomes the above mentioned problems of the prior art while providing added desirable features.

Another feature of the present invention is to provide a work light assembly integrating therewith a dust-proof sealed housing including wireless networking technology to establish two-way wireless communication and the download of cellular phone and other mobile device applications, such as music, internet access, etc., through Bluetooth and WiFi wireless networking technology.

Another feature of the present invention is to provide a work light assembly integrating therewith a dust-proof sealed housing equipped to provide ac outlets, USB ports, as well as charging USB ports and one or more docking stations or supports for cellular/mobile communication devices.

According to the above features, from a broad aspect, the present invention provides a work light assembly connected to a support. The support has a bottom ground engaging frame. The work light assembly also has at least one work light connected to an above-ground frame to provide orientation of the work light. A dust proof sealed housing is also provided and incorporates therein wireless network technology to establish two-way wireless communication of a user person with a remote location through a speaker with integrated microphone. A voltage supply is connectable to supply the at least one work light and circuitry of the wireless networking technology.

### DESCRIPTION OF THE DRAWINGS

A preferred embodiment of the present invention will now be described with reference to the accompanying drawings in which:

FIG. 1 is a front perspective view of the work light assembly of the present invention;

FIG. 2 is a front view of the work light assembly;

FIG. 3 is a side view of the work light assembly, and

FIG. 4 is another side view of the work light assembly partly sectioned to show internal parts thereof.

### DESCRIPTION OF THE PREFERRED EMBODIMENT

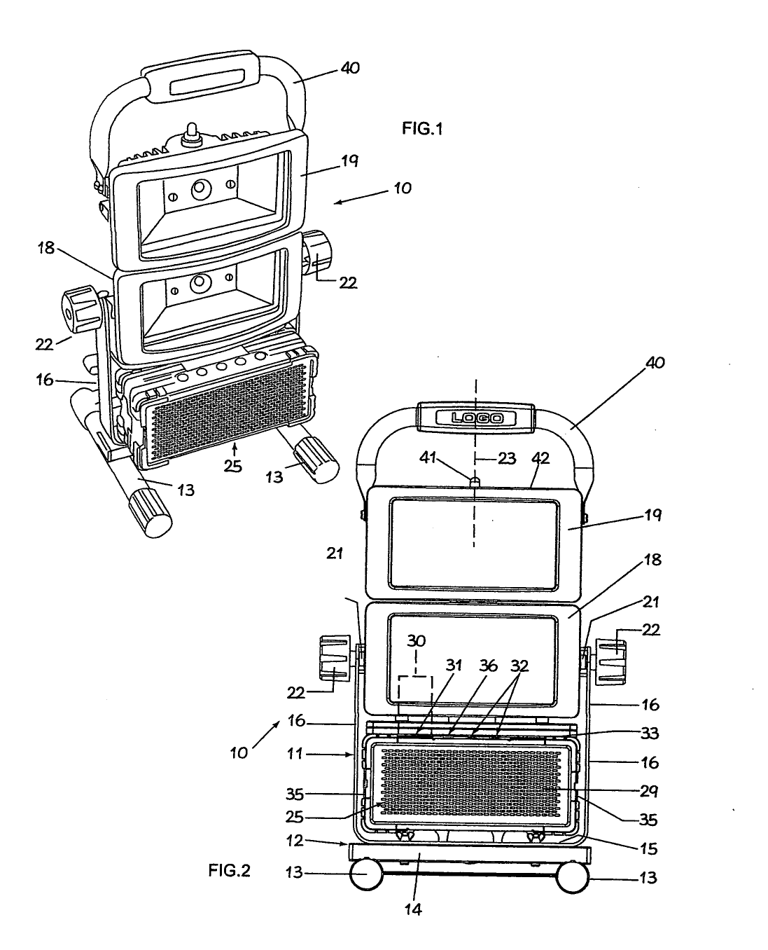

Referring now to the drawings, and more particularly to FIGS. 1 and 2, there is illustrated generally by reference numeral 10 an embodiment of the work light assembly of the present invention. The work light assembly 10 is connected to a support 11 having a bottom ground engaging frame 12, herein comprised by a pair of tubular legs 13 held spaced-apart in parallel relationship by a cross bar 14. A U-shaped support is formed from a flat metal piece to define a flat straight base member 15 and opposed vertically projecting support arms 16. The U-shaped support base member 15 is pivotally secured to the cross bar 14 by a central pivot pin 17, see FIG. 4, to permit displacement of the U-shaped support in a horizontal plane to position the U-shape support and work lights in a desired direction relative to the ground engaging frame 12.

To the support arms 16 there is pivotally secured therebetween one or more work lights, herein two work lights 18 and 19 interconnected together by a central pivot pin assembly 20, see FIG. 4. The lower one of the work lights, namely work light 19 is pivotally connected between the vertical support arms 19, in an upper part thereof, by transversely aligned pivot support pins 21 which project in holes formed in the vertical support arms 19. The ends of the support pins 21 are threaded for engagement by knobs 22 to immovably connect the work lights between the support arms 16 at a desired position. The support pins 21 provide the orientation of the work light in a vertical plane 23 to permit the work lights to pivot up and down on the vertical plane 23. Accordingly, the work lights 18 and 19 are multi-directional work lights.

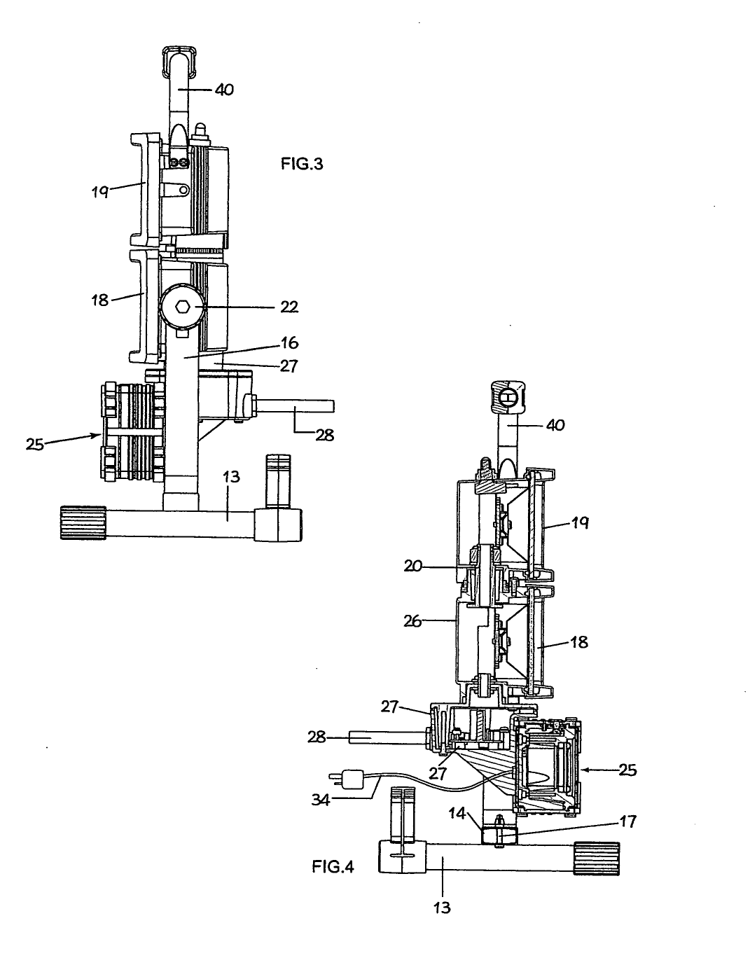

As shown more clearly with additional reference to FIGS. 3 and 4, a dust proof sealed housing 25 is immovably connected to the housing 26 of the lower work light 18 through a connecting block 27 secured thereunder and moves with the displacement of the work light 18. A projecting arm 28 extend rearwards of the connecting block 27 to tilt the hot work lights when illuminated to adjust their position on the vertical plane 23. Of course, the dust proof sealed housing 25 could also be immovably secured between the vertically projecting support arms 16 spaced under the lower work light 18.

In the dust proof sealed housing 25 there is mounted circuitry, not shown but obvious to a person skilled in the art, for wireless network technology access whereby to establish two way communication between a user person and a remote location. The housing 25 supports circuitry for wireless networking technology including, but not limited to, Bluetooth and WiFi. A speaker 29 with integrated microphone 29′, also well known in the art is mounted in the housing 25 to establish the two way communication. The speaker also provides for music or other audio information downloaded from a cellular device 30 connected to the housing 25 in a docking station 31 or connected to one of the USB ports 32 provided in the top wall 33 of the housing 25 through a USB cable, as is obvious to a person skilled in the art.

To the housing 25 there is also connected an ac voltage cable 34 to provide the ac supply for the work lights which generate up to 5000 lumens each and to an AC/DC converter or driver to provide the necessary operating voltage for the wireless network devices mounted in the housing 25. AC outlet connectors 35 may also be conveniently mounted on the housing 25 to provide power to other local ac powered devices. A charging USB port 36 is also mounted on the top wall 33 of the housing 25 to charge mobile devices, such as running software including, but not limited to, IOS, Android and Windows.

The work light assembly 10 is further provided with a handle 40 secured to the uppermost work light 19 and projects thereabove making the assembly easily portable. A switch 41 provided with a silicon cover is mounted on the top wall 42 of the uppermost work light 19 to switch the power on and off. Instead of the ac supply cord connection 28, a dc battery housing can be conveniently integrated with the assembly to make work light assembly 10 usable at locations where there is no ac power outlets.

As one can appreciate, to a user trade person, the present invention overcomes all of the previously mentioned prior art problems and provides numerous new functions and wireless networking technologies all in a single work light assembly. Accordingly, to an on worksite user person, there is provided the necessary orientable lighting as well as instantaneous two way communication and accessories, such as a docking station to secure the user persons mobile cellular device and providing him with access to the internet as required. As well, audio music can be downloaded into the speaker to provide music on a work site.

It is within the ambit of the present invention to provide any obvious modifications to the preferred embodiment and examples described herein, provided such modifications fall with the scope of the appended claims. For example, mthe support for the work light may have several different configurations to support the work lights as well as supporting the dust proof sealed housing incorporating therein the wireless components.

1. A work light assembly connected to a support, said support having a bottom ground engaging frame, said work light assembly having two work lights connected to a horizontal above-ground frame and pivotally connected thereto to provide an orientation of each said work lights in a horizontal and a vertical direction independently from one another, said support having a U-shaped support formed by opposed vertical support arms pivotally secured to an horizontal ground engaging frame for axial rotation of said U-shaped support to provide vertical axial rotation of said work light assembly about said ground engaging frame, a lower one of said two work lights being pivotally connected between the opposed vertical support arms by transversely aligned pivot support pins lockingly securable to each said opposed vertical support arms, an upper one of said two work lights being pivotally connected to said lower one of said two work lights by a central vertical pin assembly, a dust proof sealed housing connected to between said support arms below said two work lights and incorporating therein wireless network technology to establish two-way wireless communication of a user person with a remote location, and a voltage supply for powering said at least one work light and circuitry of said wireless networking technology.

2. (canceled)

3. (canceled)

4. (canceled)

5. The work light assembly as claimed in claim 1 wherein said network technology comprises Bluetooth wireless technology wherein to establish cellular communication through mobile devices, such as smart phones, tablets, music player and any other compatible device.

6. The work light assembly as claimed in claim 5 wherein said network device further comprises WiFi wireless networking technology to allow wireless high speed internet and network connections.

7. The work light assembly as claimed in claim 1 there is further provided a mobile device holder/docking station on said dust proof sealed housing.

8. The work light assembly as claimed in claim 1 wherein there is further provided one or more USB ports in said dust proof sealed housing.

9. (canceled)

10. The work light assembly as claimed in claim 1 wherein each said work lights generate up to about 5,000 lumens.

11. The work light assembly as claimed in claim 1 wherein said power supply is an ac voltage supply, and one or more ac outlets secured to said dust proof sealed housing to provide power to other ac powered devices.

12. The work light assembly as claimed in claim 1 wherein one or more USB power ports are secured to said dust proof sealed housing for charging portable mobile devices through a USB connection.

13. The work light assembly as claimed in claim 6 wherein said dust proof sealed housing has a driver circuit incorporating an ac/dc converter circuit to provide a dc supply voltage to supply circuits associated with said wireless communication speaker with microphone and associated wireless circuits of said Bluetooth and WiFi networking technology circuits.

14. (canceled)

15. (canceled)

16. The work light assembly as claimed in claim 1 wherein said user person is a trade person performing a job function, said remote location including a speaker with an integrated microphone for access to said user person for exchanging information relating to said job function.

17. The work light assembly as claimed in claim 16 wherein said job function requires said at least one work light to permit said user person the efficiently perform said job function.
